(19) United States
(12) Patent Application Publication
(10) Pub. No.: US 2006/0286283 A1
(43) Pub. Date: Dec. 21, 2006

(54) Luminous candy

(75) Inventor: Jeong Min Yoon, Seoul (KR)

Correspondence Address: JORDAN AND HAMBURG LLP, 122 EAST 42ND STREET, SUITE 4000, NEW YORK, NY, 10168, US

(73) Assignee: GF Co., Ltd., Kyounggi-do (KR)

(21) Appl. No.: 11/177,263

(22) Filed: Jul. 7, 2005

(30) Foreign Application Priority Data
Jun. 16, 2005 (KR) 20-2005-16768

(51) Int. Cl. A23G 3/00

(52) U.S. Cl. 426/658

(57) ABSTRACT

A luminous candy functioning as both a favorite food and a lighting toy by showing a visual effect is disclosed. The luminous candy comprises: a body portion; a stick portion a portion of which is inserted into the body portion; and a luminous portion provided in the stick portion so that the light is emitted when the stick portion is bent. The body portion and the stick portion are transparent. Since the light is reflected through the body portion and the stick portion of the candy to provide unique visual effect, the curiosity and taste of the various consumers such as children, juveniles, and lovers is effectively stimulated, improving the value added of the product.

### BACKGROUND OF THE INVENTION

1. Field of the invention

The present invention relates to a luminous candy functioning as both a favorite food and a lighting toy having a visual effect.

2. Description of the Prior Art

Generally, candies which are a favorite food are mainly consumed by children, and have various shapes such as balls and bars to satisfy the curiosity and entertain the children, and are manufactured so as to have various tastes of strawberries, peppermints, peaches, etc.

Recently, candies that taste good and having visual effects appealing to children are being produced by manufacturing them to be transparent and inserting pictures of worms, insects, fruits, etc. into them.

However, since conventional candies have no distinguishing characteristics except for the pictures inserted into the candies and providing visual effects, they cannot evoke interest from consumers; mostly juveniles, lovers, and children. Therefore, the value added to the product lowers.

### SUMMARY OF THE INVENTION

Accordingly, the present invention has been made to solve the above-mentioned problems occurring in the prior art, and an object of the present invention is to provide a luminous candy in which the light emitted by bending a stick portion extends into a body portion through a receiving space in the stick portion so that the body portion and the stick portion of the candy are luminated, thereby satisfying the curiosity and taste of consumers and improving the value added of the product.

In order to accomplish this object, there is provided a luminous candy comprising: a body portion; a stick portion a portion of which is inserted into the body portion; and a luminous portion provided in the stick portion so that the light is emitted when the stick portion is bent, the body portion and the stick portion being transparent.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view for showing a luminous candy according to the present invention;

FIG. 2 is a plan view of FIG. 1; and

FIG. 3 is a perspective view for showing a candy according to another preferred embodiment of the present invention.

### DETAILED DESCRIPTION OF THE PREFERRED EMBODIMENTS

Hereinafter, a preferred embodiment of the present invention will be described with reference to the accompanying drawings.

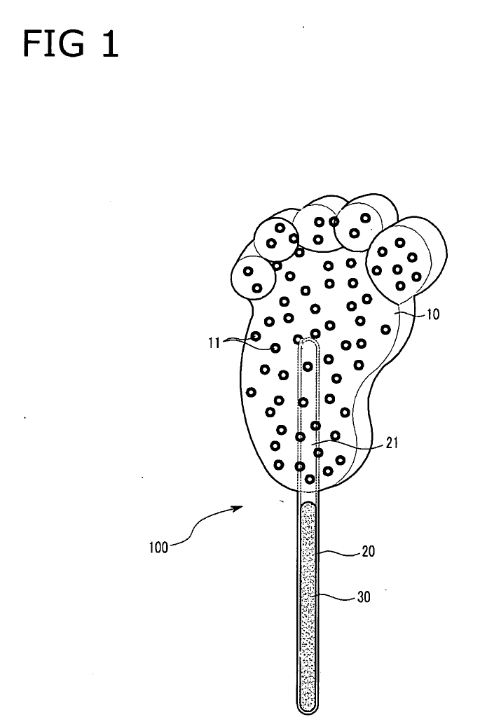

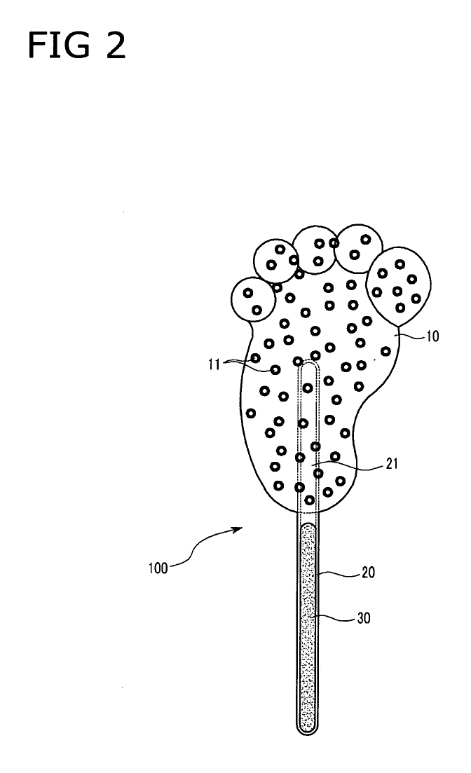

FIG. 1 is a perspective view for showing a luminous candy according to the present invention. FIG. 2 is a plan view of FIG. 1;

As shown in FIGS. 1 and 2, the luminous candy 100 according to the present invention is transparent, and has various shapes of a human body such as the palm of a hand or the sole of a foot, a fruit, an animal to invoke the curiosity and interest of a consumer. The luminous candy 100 includes an edible body portion 10 manufactured so as to have various tastes of a strawberry, a peppermint, a peach, etc., and a stick portion 20 a portion of which is inserted into the body portion 10 to function as a knob supporting the body portion 10. The stick portion 20 is made of a material such as a plastic tube etc.

Further, a receiving space 21 extending vertically from the upper end of the stick portion 20 to the lower end thereof is formed in the stick portion 20. A luminous portion 30 emitting the light when the stick portion 20 is bent is provided in the receiving space 21.

The luminous portion 30 provided in the stick portion 20 preferably uses the chemical light. The chemical light emits the light when a luminous medium material meets a fluorescent molecule of a reaction catalyst. The chemical light has a structure in which a medium material is filled in a closed glass tube and is filled in a plastic tube together with a reaction liquid. Therefore, if the plastic tube is bent, the glass tube in the plastic tube is broken and the two chemical materials react with each other and emit the light. The chemical light has a mechanism which does not generate heat.

Then, a plurality of small granules can be accommodated in the body portion 10 so that they can show unique luminous effects when the luminous liquid of the luminous portion 30 is introduced into the body portion 10 through the receiving space 21 of the stick portion 20.

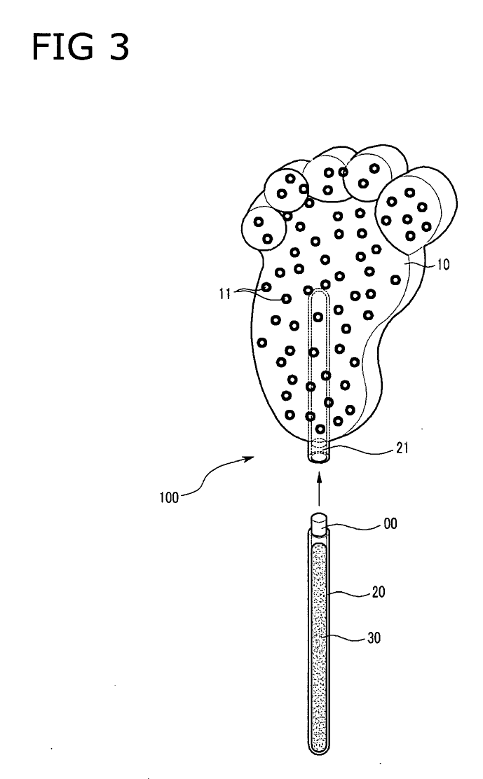

On the other hand, as shown in FIG. 3, the stick portion 20 can include an insertion portion 20a inserted into the interior of the body portion 10 and a knob portion 20b functioning as a knob and having the luminous portion 30 therein. Then, the lower end 22 of the insertion portion 20a is combined with the upper end 23 of the knob portion 20b. The combination of the insertion portion 20a and the knob portion 20b can be performed by using a pin combining structure including a recess 22 and a boss 23, by a screw combining structure having a screw portion, or the like.

According to the luminous candy 100 of the present invention, if the stick portion 20 is lightly bent and the glass tube of the luminous portion 30 provided in the stick portion 20 is broken, the chemical reaction of the luminous liquid contained in the luminous portion 30 becomes active and the light is emitted. Then, since the luminous liquid emits the light in the transparent stick portion 20 and is introduced into the body portion 10 along the receiving space 21 in the stick portion 20 to function as a light emitting plate, the body portion 10 and the stick portion 20 of the candy 100 emits the light simultaneously.

Then, the small granules 11 distributed in the body portion 10 reflect the emitted light at various angles to show unique visual effects.

Although a preferred embodiment of the present invention has been described for illustrative purposes, those skilled in the art will appreciate that various modifications, additions and substitutions are possible, without departing from the scope and spirit of the invention as disclosed in the accompanying claims.

For example, the body portion 10 and the stick portion 20 can provide visual elegance by coating a thin outer layer thereon with various colors.

Namely, since during the operation of the luminous portion 30, the outer layer formed on the body portion 10 and the stick portion 20 functions like cellophane, more unique visual effects in which the light of various colors is emitted can be obtained.

As mentioned above, according to the luminous candy according to the present invention, since the light is radiated through the body portion and the stick portion of the candy to provide unique visual effect, the curiosity and taste of the consumers such as children, juveniles, and lovers are effectively entertained. Therefore, the luminous candy can be used in an amusement park or at a party or a event, improving the value added of the product.

What is claimed is:

1. A luminous candy comprising:
a body portion;
a stick portion a portion of which is inserted into the body portion; and
a luminous portion provided in the stick portion so that the light is emitted when the stick portion is bent, the body portion and the stick portion being transparent.

2. A luminous candy according to claim 1, wherein the luminous portion is the chemical light.

3. A luminous candy according to claim 1, wherein a plurality of granules are received and distributed in the body portion.

4. A luminous candy according to claim 1, wherein the body portion and the stick portion have various colors.

5. A luminous candy according to claim 1, wherein the stick portion includes an insertion portion inserted into the interior of the body portion and a knob portion in which the luminous portion is formed.
